(19) United States
(12) Patent Application Publication
(10) Pub. No.: US 2026/0101013 A1
(43) Pub. Date: Apr. 9, 2026

(54) STORAGE MEDIUM STORING PROGRAM SUPPORTING GENERAL-PURPOSE SOFTWARE, METHOD AND INFORMATION PROCESSING APPARATUS

(71) Applicant: CANON KABUSHIKI KAISHA, Tokyo (JP)

(72) Inventor: JUN ITOH, Chiba (JP)

(21) Appl. No.: 19/347,497

(22) Filed: Oct. 1, 2025

(30) Foreign Application Priority Data
Oct. 3, 2024 (JP) 2024-174618

(51) Int. Cl. H04N 1/393; G06F 3/12

(52) U.S. Cl. CPC H04N 1/393; G06F 3/1205; G06F 3/1258

(57) ABSTRACT

A non-transitory computer-readable storage medium that stores a program supporting general-purpose software available for image processing apparatuses provided by a plurality of manufacturers, wherein, when executed, the program causes a computer to perform a method that includes causing a display unit to display an object that receives a setting related to a scaling function of scaling an image acquired by reading a document using the image processing apparatus, and outputting a reading instruction of the document to the image processing apparatus according to the setting received by the object.

### BACKGROUND

### Field of the Technology

The present disclosure relates to a storage medium that stores a program supporting general-purpose software, a method, and an information processing apparatus.

### Description of the Related Art

A known configuration involves a scanning driver installed in a host computer as control software for a scanning device. This driver issues a reading instruction to the scanning device connected to the host computer. An operating system (OS), which is basic software, is installed in the host computer, and the scanning driver is configured in accordance with specifications defined by the OS, and is called by the OS to operate. A vendor (manufacturer) that provides the scanning device can provide a means for instructing the scanning device to perform reading using the OS by providing a scanning driver that conforms to the specifications of the OS.

In recent years, in Windows^{®}, a standard class driver (hereinafter, also referred to as a “standard driver”) commonly available in scanning devices provided by a plurality of vendors has tended to be provided. Such standard driver is included in the OS package, and can be easily used by connecting an arbitrary scanning device to a host computer. Therefore, it is not necessary to separately install a scanning driver specific to the model suitable for the scanning device, and convenience is high. Further, it is assumed that the standard driver is configured to be able to specify a scanning function according to scanning function information generated based on information acquired from a connected scanning device. As a result, a user who uses the standard driver can specify the scanning function according to the capability of the connected scanning device even though the user uses one standard driver. However, since this is only a function that can be realized only by the standard driver, a unique function of the vendor (manufacturer) of the scanning device cannot be specified.

Therefore, Japanese Patent Laid-Open No. 2021-033526 discloses a program for extending a printing function of general-purpose software.

Here, as a function of a scanning driver unique to a vendor of the scanning device, there is a scaling function. The scaling function is a function of performing scanning of image data with enlargement or reduction.

The scaling function includes, in addition to a function of directly setting a magnification to be enlarged or reduced, a fixed scaling function of specifying a magnification by selecting a previously prepared setting, such as enlargement from A4 size to A3 size. The scaling function further includes an automatic scaling function of automatically performing enlargement or reduction from a document size to a specified recording size of a scanned image.

By using this function, a user can acquire image data that has been enlarged or reduced to a specified size.

While the scaling function is typically available through vendor-specific driver, it may not be accessible when using the standard driver.

### SUMMARY

In view of the above-described problem, the present disclosure is directed to providing a mechanism that enables the reception of settings related to a scaling function by executing a program supporting general-purpose software available for image processing apparatuses provided by a plurality of manufacturers.

In order to solve the above-described problem, an information processing apparatus according to one aspect of the present disclosure has the following configuration.

The present disclosure is directed to a non-transitory computer-readable storage medium that stores a program supporting general-purpose software available for image processing apparatuses provided by a plurality of manufacturers, wherein, when executed, the program causes a computer to perform a method that includes causing a display unit to display an object that receives a setting related to a scaling function of scaling an image acquired by reading a document using the image processing apparatus; and outputting a reading instruction of the document to the image processing apparatus according to the setting received by the object.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of a scanning system according to embodiments.

FIG. 2A is a software configuration diagram of the scanning system according to the embodiments.

FIG. 2B is a software configuration diagram of the scanning system according to the embodiments.

FIG. 3A is a diagram showing a scanning setting screen according to an embodiment 1.

FIG. 3B is a diagram showing a detailed setting screen according to the embodiment 1.

FIG. 3C is a diagram showing a detailed setting screen according to the embodiment 1.

FIG. 3D is a diagram showing a detailed setting screen according to the embodiment 1.

FIG. 3E is a diagram showing a detailed setting screen according to the embodiment 1.

FIG. 3F is a diagram showing a detailed setting screen according to the embodiment 1.

FIG. 4 is a flowchart of a scanning function information editing process performed by an extension application according to the embodiment 1.

FIG. 5 is a diagram showing scanning function lists of each apparatus according to the embodiment 1.

FIG. 6 is a sequence diagram showing a scanning operation according to the embodiment 1.

FIG. 7 is a flowchart showing a scanning process in the extension application according to the embodiment 1.

FIG. 8A is a flowchart showing a scanning process performed by a scanning device according to the embodiment 1.

FIG. 8B is a flowchart showing a scanning process performed by a scanning device according to the embodiment 1.

FIG. 9 is a flowchart showing an additional process of a scaling function of an extension application according to an embodiment 2.

FIG. 10 is a sequence diagram showing a scanning operation according to the embodiment 2.

FIG. 11 is a flowchart showing a scanning process in the extension application according to the embodiment 2.

FIG. 12 is a sequence diagram showing a scanning operation according to an embodiment 3.

FIG. 13 is a sequence diagram showing a scanning operation according to the embodiment 3.

FIG. 14 is a sequence diagram showing a scanning operation according to an embodiment 4.

FIG. 15 is a flowchart showing a scanning process in an extension application according to the embodiment 4.

### DESCRIPTION OF THE EMBODIMENTS

Hereinafter, embodiments of the present disclosure will be described in detail with reference to the accompanying drawings. Note that the following embodiments do not limit the present disclosure in the claims, and all combinations of features described in the embodiments are not necessarily essential to the solution of the present disclosure.

### Embodiment 1

### Hardware Configuration of Scanning System

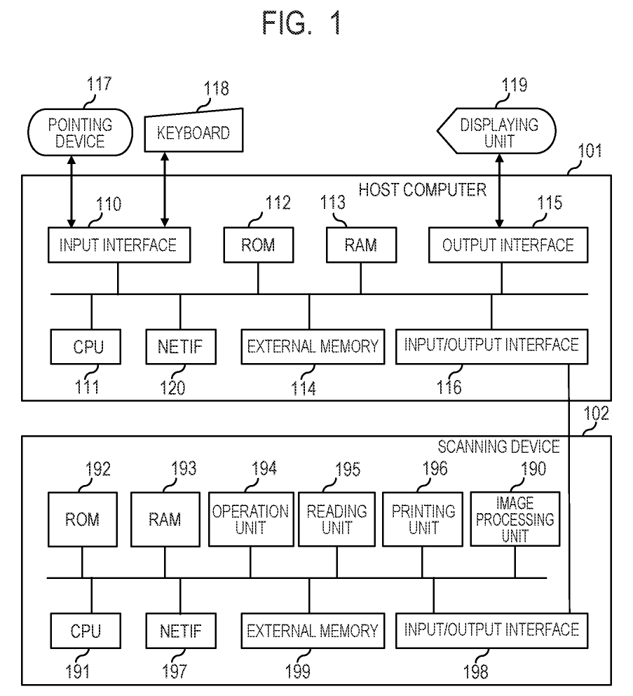

FIG. 1 is a block diagram showing a hardware configuration of a scanning system.

### Host Computer

In FIG. 1, a host computer 101 is an example of an information processing apparatus, and includes an input interface 110, a CPU 111, a ROM 112, a RAM 113, an external memory 114, an output interface 115, and an input/output interface 116. Inputting devices such as a keyboard 118, a pointing device 117 and the like are connected to the input interface 110, and a display device such as a displaying unit 119 is connected to the output interface 115. An NETIF 120 is a network interface, and performs control for performing data transfer with an external device via a network.

The ROM 112 stores an initialization program. The external memory 114 is, for example, a hard disk drive (HDD) or a solid state drive (SSD). The external memory 114 stores application programs, an operating system (OS), and various other data. The RAM 113 is used as a work memory or the like when executing various programs stored in the external memory 114, and the various programs can operate in the host computer 101.

In the present embodiment, the CPU 111 performs processes in accordance with codes of programs stored in the ROM 112, thereby executing later-described functions of the host computer 101 and processes according to later-described flowcharts.

### Scanning Device

A scanning device 102 is an example of an image reading apparatus, and is connected to the host computer 101 via an input/output interface 198 of the scanning device 102 and the input/output interface 116 of the host computer 101. The input/output interface 198 of the scanning device 102 and the input/output interface 116 of the host computer 101 may be a wired network or a wireless network.

The scanning device 102, which is the image reading apparatus, includes a CPU 191, a ROM 192, a RAM 193, an operation unit 194, a reading unit 195, a printing unit 196, an NETIF 197, the input/output interface 198, and an external memory 199.

The CPU 191 comprehensively controls the scanning device 102.

The ROM 192 is a memory that stores programs.

The RAM 193 is a memory that temporarily stores programs and image data. The reading unit 195 is a scanner, and reads an image of a document.

The printing unit 196 prints an image on a sheet based on the image data. The printing unit 196 is not essential.

The NETIF 197 is a network interface, and performs control for performing data transfer with an external device via a network.

An image processing unit 190 performs various image editing processes for the input image data.

Here, the host computer 101 and the scanning device 102 are separately configured, but they may be configured as one information processing apparatus. A reading setting screen and a detailed setting screen described later are displayed on the displaying unit 119. In the present embodiment, an electrophotographic digital multifunction peripheral having a plurality of functions such as copying, printing, and FAX will be described as an example of the scanning device. However, the present embodiment is not limited to this, and the present embodiment can also be applied to a device that uses another process such as an ink jet method, or to a scanner that performs only image reading. The host computer 101 may be a desktop computer, a smartphone, or a notebook computer.

### Software Configuration of Scanning System

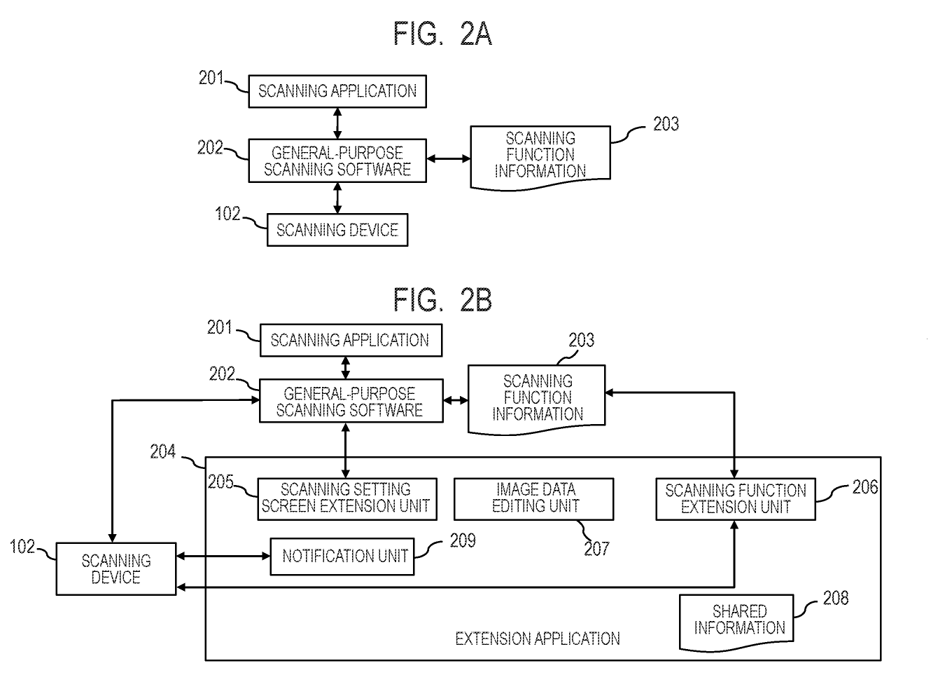

FIGS. 2A and 2B are diagrams schematically showing software configurations of the scanning system. The software configurations of FIGS. 2A and 2B are stored in the external memory 114 of FIG. 1. Here, a description will be given on the assumption of a scanning system using the host computer 101 equipped with Windows^{®}11 of Microsoft^{®} as the OS. Note that a standard driver is also provided in Apple MacOS^{®}, and the present technology can be applied thereto.

FIG. 2A is the diagram showing a general configuration in a case where an extension application 204 is not associated with general-purpose scanning software 202 and the scanning device 102.

FIG. 2B is the diagram showing a configuration in a case where the extension application 204 is associated with the general-purpose scanning software 202 and the scanning device 102.

### Software Configuration of Scanning System (Not Associated with Extension Application

First, with reference to FIG. 2A, a configuration of the scanning system in a case where the extension application 204 is not associated will be described.

A scanning application 201 is software for capturing scanned contents (image data). For example, this application corresponds to a document creation application or an image editing application. Upon receiving a scanning request from a user, the scanning application 201 issues a scanning instruction to the OS. The scanning instruction includes scanning setting information for instructing operations of the general-purpose scanning software 202 and the scanning device 102.

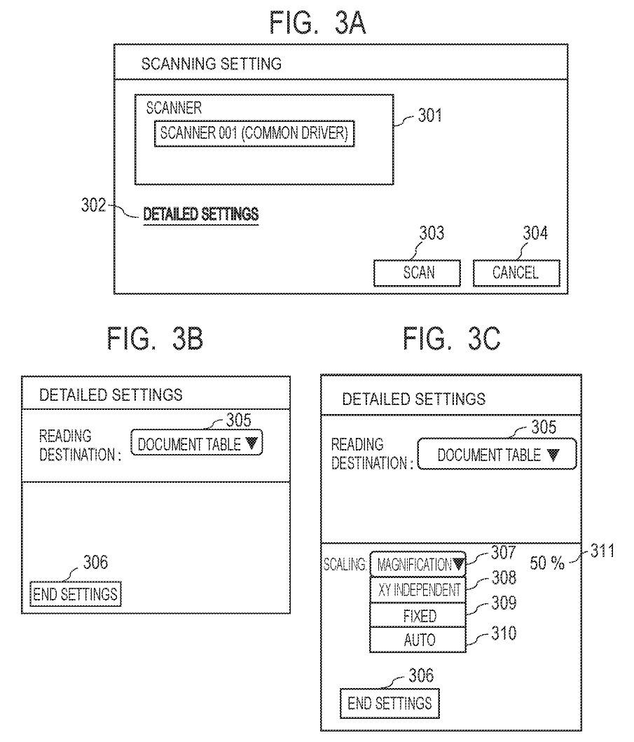

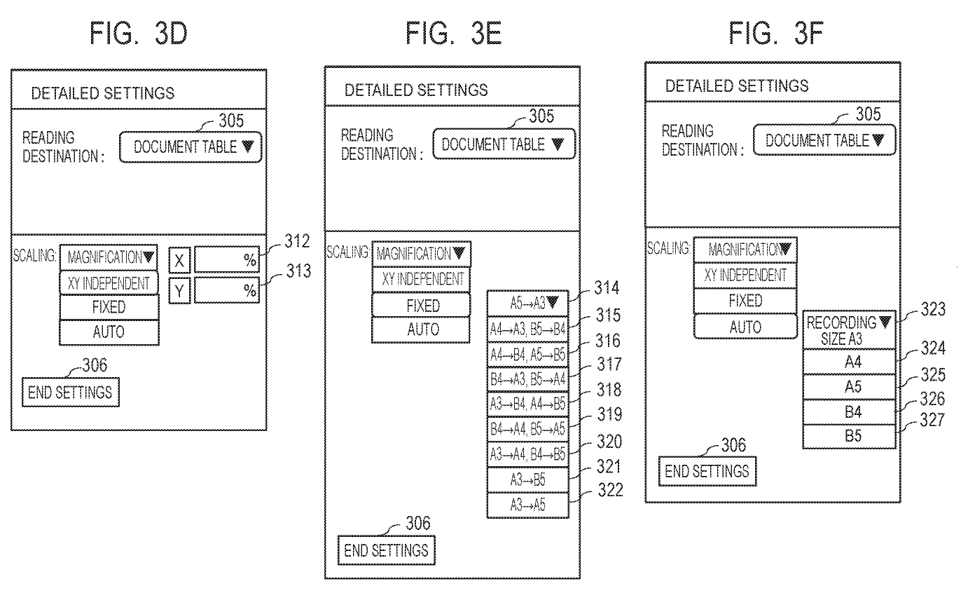

In order to execute the scanning instruction, the scanning application 201 can display a scanning setting screen provided by any of the general-purpose scanning software 202, the OS, and the scanning application 201. When a detailed setting in the scanning setting screen is pressed, the general-purpose scanning software 202 additionally displays the detailed setting screen. The scanning setting screen and the detailed setting screen will be described later with reference to FIGS. 3A to 3F. The detailed setting screen includes a setting item (hereinafter, also referred to as “a control item”) indicating a settable scanning function and a control item indicating a setting value thereof, according to capability information (settable information) of the general-purpose scanning software 202.

The general-purpose scanning software 202 determines a scanning capability based on scanning function information 203.

The scanning function information 203 is data indicating all settable scanning functions, setting values thereof, and scanning functions in which exclusive relationships between the setting values are described. The scanning function information 203 is included in the configuration file of the general-purpose scanning software 202, and is arranged in the external memory 114 as an unchangeable file. Alternatively, the scanning function information 203 can be dynamically generated by the general-purpose scanning software 202. Specifically, the general-purpose scanning software 202 or the OS can be configured to acquire attribute data of the scanning device from the scanning device 102 and generate the scanning function information 203 according to attribute information in the acquired attribute data. When the scanning function information 203 is dynamically generated, the generated scanning function information 203 can be edited. The attribute data of the scanning device acquired from the scanning device 102 includes attribute information indicating a scanning function (capability of the scanning device) that can be specified by the scanning device 102 and a setting value related to the attribute information. This information is stored in the RAM 113.

With this configuration, the general-purpose scanning software 202 can be configured so that the user can specify the scanning function that can be used by each scanning device 102 according to the connected scanning device 102. That is, even when a scanning device having different functions or a scanning device developed by a different vendor is connected, the general-purpose scanning software 202 can be configured so that the user can specify the scanning function that can be used according to the connected scanning device. The general-purpose scanning software 202 can generate the scanning instruction that can be interpreted by a plurality of scanning devices manufactured by different vendors, and output the scanning instruction to each of the plurality of scanning devices manufactured by different vendors. The vendor may be a manufacturer of the scanning device 102. Here, the general-purpose scanning software 202 is a standard class driver that executes scanning based on a standard scanning protocol called “Mopria”. The general-purpose scanning software 202 acquires capability information of the connected scanning device 102 so that the user can specify the scanning function supported by the connected scanning device 102, and generates the scanning function information 203 based on the acquired information. The general-purpose scanning software 202 acquires the scanning function information 203 from the scanning device 102 by IPP (Internet Printing Protocol), and receives the image data generated by scanning the document by the scanning device 102. However, the general-purpose scanning software 202 does not support a scaling function. This is because the scaling function is a unique function of a vendor (a manufacturer of the scanning device) of the scanning device.

### Scaling Function

The scaling function is a function for enlarging or reducing image data. In the scaling function, a user directly sets a magnification (scaling factor) of enlargement/reduction and generates image data in which an image has been subjected to an enlarging/reducing process according to the specified scaling factor. This is called magnification specifying in the present embodiment. As for the scaling factor, different magnifications may be set between the vertical and horizontal directions of an image, and this is called XY independent scaling in the present embodiment.

In addition to the function in which the user directly sets the scaling factor, there is also a function in which the magnification is specified by selecting a previously prepared setting such as enlargement from A4 size to A3 size. This is called fixed scaling in the present embodiment. The options for setting the fixed scaling are not limited to those listed in the present embodiment.

There is also a function for automatically calculating a scaling factor based on a document size and a user-specified recording size of a scanned image and performing enlargement/reduction. This is called automatic scaling in the present embodiment. The options of the recording size in the automatic scaling are not limited to those listed in the present embodiment.

In the present embodiment, an image process of enlargement/reduction is performed by an ASIC of the image processing unit 190, but the enlargement/reduction process is not limited to this method, and the image process of enlargement/reduction may be performed by software, for example.

### Software Configuration of Scanning System (Associated with Extension Application

Next, with reference to FIG. 2B, a configuration of the scanning system in a case where the extension application 204 is associated will be described. Note that description of the same configurations as those in FIG. 2A will be omitted.

The extension application 204 is software for extending or supporting the functions of the general-purpose scanning software 202, and is also called a support application. The extension application 204 is software that is not included in the OS in advance (not packaged). Therefore, it is necessary for the user to operate the host computer 101 to download and install the extension application 204 from the server via the Internet. Alternatively, it may be automatically installed based on the fact that the scanning device 102 is connected to the host computer 101. Specifically, when the scanning device 102 is connected to the host computer 101, the OS acquires device discrimination information from the scanning device 102. The OS may download and install the extension application 204 corresponding to the acquired device discrimination information from the server via the Internet. That is, the general-purpose scanning software 202 and the extension application 204 are held in the host computer 101 as separate files.

Although the general-purpose scanning software 202 and the extension application 204 may be updated and upgraded, the update processes are also performed at different timings. That is, the timing at which the general-purpose scanning software 202 is acquired by the host computer 101 is different from the timing at which the extension application 204 is acquired. Further, a trigger for acquiring the general-purpose scanning software 202 by the host computer 101 and a trigger for acquiring the extension application 204 are also different. When the extension application 204 is installed, the OS associates the extension application 204 with the general-purpose scanning software 202 and the scanning device 102.

The extension application 204 described in the present embodiment includes a scanning setting screen extension unit 205, a scanning function extension unit 206, an image data editing unit 207, and a notification unit 209. The extension application 204 also includes shared information 208 that can be commonly accessed by each unit. The state of the shared information 208 is a file stored in the external memory 114 or information stored in the RAM 113. The extension application 204 uses API (Application Program Interface) provided by the OS to write or read information to or from the shared information 208.

Note that the extension application 204 may end the operation every time the process of each unit ends. In this case, the OS activates the extension application 204 every time a request to use each unit is received.

Further, the extension application 204 may cancel the process in the process of each unit. When the process is canceled, a job being processed is deleted by the OS.

Upon receiving a scanning request from the user, the scanning application 201 issues the scanning instruction to the OS. Also under this configuration, the scanning application 201 can display the scanning setting screen as in the configuration of FIG. 2A. In this configuration, the detailed setting screen provided by the extension application 204 is displayed. Specifically, the detailed setting screen provided by the scanning setting screen extension unit 205 included in the extension application 204 is displayed. The scanning setting screen extension unit 205 can store detailed settings set by the user in the shared information 208.

The extension application 204 includes the image data editing unit 207. The image data editing unit 207 acquires the image data from the scanning device 102 and edits the acquired image data. The image data editing unit 207 acquires detailed setting information from the shared information 208, and performs image editing according to the detailed setting on the image data. The extension application 204 may be configured to acquire the image data acquired by the general-purpose scanning software 202 and perform the image editing according to the detailed settings on the image data.

Also, even in the configuration of FIG. 2B, there is a case where scaling setting is not performed by the user. In this case, as in the configuration of FIG. 2A, the general-purpose scanning software 202 may issue a scanning request instruction to the scanning device 102 without going through the extension application 204.

The extension application 204 includes the scanning function extension unit 206. The scanning function extension unit 206 can edit the scanning function information 203 generated by the general-purpose scanning software 202 or the OS. Thus, the scanning function extension unit 206 can add a function provided by the extension application 204. In addition, the scanning function extension unit 206 can add a function (scaling function) which is supported by the scanning device 102 but is not supported by the general-purpose scanning software 202, add an exclusive relationship between setting values of scanning functions, and the like. The OS activates the scanning function extension unit 206 when the extension application 204 is initially associated with the scanning device 102 and the general-purpose scanning software 202. Further, the OS may activate the scanning function extension unit 206 at another timing such as when the OS is activated.

The extension application 204 also includes the notification unit 209. The notification unit 209 can display a notification to the user in response to occurrence of an error in the scanning device 102. For example, when a reading jam error occurs in the scanning device 102, the general-purpose scanning software 202 detects the occurrence of the reading jam error, and the OS causes the displaying unit 119 to display a message using a notification function called a toast notification, which is a function of the OS. When the user presses the toast notification, the notification unit 209 of the extension application 204 is called by the OS, and a UI screen of the notification unit 209 is displayed. On the UI screen of the notification unit 209, for example, a detailed message of a scanning jam error or a jam release method can be displayed.

The configuration of the extension application 204 for realizing the present embodiment is not limited to a configuration having all of the above-described functions (units), and may be a configuration having only a part of the functions or a configuration having other functions. The extension application 204 may be simply referred to as scanning software.

As described above, it can be said that the extension application 204 includes at least one of the following functions.

The first function is to display the setting screen (scanning setting screen extension unit 205).

The second function is to edit the image data according to the detailed setting (image data editing unit 207).

The third function is to extend the function that can be specified by image data generation software (scanning function extension unit 206).

The fourth function is to display the screen in response to the occurrence of the error in the scanning device 102 (notification unit 209).

### Setting Screen

Next, an example of the scanning setting screen and the detailed setting screens according to the present embodiment will be described with reference to FIGS. 3A to 3F.

FIG. 3A is the diagram showing the scanning setting screen displayed by the scanning application 201.

FIG. 3B is the diagram showing the detailed setting screen displayed in a case where the extension application 204 shown in FIG. 2A is not provided.

FIG. 3C is the diagram showing the detailed setting screen displayed in a case where the extension application 204 shown in FIG. 2B is provided.

The units and modules for displaying the scanning setting screen are not limited to those described above.

For example, the scanning setting screen extension unit 205 may be configured to generate only a display screen. In this case, the scanning setting screen extension unit 205 transmits the generated display screen to the scanning application 201 via the general-purpose scanning software 202. The scanning application 201 may be configured to display the acquired display screen.

### Scanning Setting Screen (Scanning Application)

First, the scanning setting screen displayed by the scanning application 201 of FIG. 3A will be described.

A control 301 includes objects for allowing the user to set a scanner (scanner used for reading) to which the image data is scanned.

A control 302 is a detailed setting button, and when the control 302 is pressed, an additional printing screen is displayed by the general-purpose scanning software 202 or the scanning setting screen extension unit 205.

A control 303 is a scanning start button, and a control 304 is a scanning cancel button.

### Detailed Setting Screen (General-Purpose Scanning Software)

Next, FIG. 3B will be described. FIG. 3B is the diagram showing an additional setting screen displayed by the general-purpose scanning software 202 when the extension application 204 is not provided.

A control 305 indicates that a reading destination can be set and a document table is selected.

A control 306 is a setting end button, and when the control 306 is pressed, the screen returns to the scanning setting screen of FIG. 3A.

### Scanning Setting Screen (Scanning Setting Screen Extension Unit)

Next, FIGS. 3C to 3F will be described. FIGS. 3C to 3F are the diagrams respectively showing additional setting screens displayed by the scanning setting screen extension unit 205 when the extension application 204 is provided.

First, FIG. 3C will be described. Unlike FIG. 3B, a control 307 and lists 308, 309, 310 are added.

The control 307 is a button (object) that can select the scaling setting, and a scaling type can be selected. Here, the control indicates that magnification-specified scaling is selected.

When the control 307 is pressed, the list 308 to 310 indicate the setting items of the scaling types. The lists 308 to 310 indicate that, in addition to the currently selected “magnification”-specified scaling, there are “XY independent” scaling, “fixed” scaling, and “auto” scaling. By selecting the desired scaling type from the lists 308 to 310, the user sets the enlargement/reduction function and performs the scanning.

Further setting items are added to the screen according to the scaling type selected by the control 307 and the lists 308 to 310.

In the case of the magnification-specified scaling shown in FIG. 3C, a text box 311 is added so that the user can directly set the scaling factor. The user can specify the magnification by directly inputting the magnification in the text box 311 to be used for the magnification specifying.

In the case of the XY independent scaling shown in FIG. 3D, text boxes 312 and 313 for setting respective scaling factors in the vertical and horizontal directions of an image are added, and the user can set different scaling factors respectively in the vertical and horizontal directions.

In the case of the fixed scaling shown in FIG. 3E, lists 314 to 322, which are objects for specifying the scaling from a fixed size to another fixed size, are added so that the user can set enlargement/reduction to another fixed size. In the present embodiment, the settings for AB-system fixed sizes are shown, but settings for Inch-system fixed sizes such as LTR (Letter), LGL (Legal), 11×17 inch, or a combination thereof may be used. In addition, the setting items added to the screen may be switched between the AB-system and the Inch-system according to information to be treated.

In the case of the auto scaling shown in FIG. 3F, lists 323 to 327 for specifying respective sizes to be recorded as image data are added, and enlargement/reduction to a recording size specified by the user can be set.

In the present embodiment, the settings for the AB-system fixed sizes are shown as the recording sizes, but the settings for the Inch-system fixed sizes such as LTR (Letter), LGL (Legal), 11×17 inch, or a combination thereof may be used. In addition, the setting items added to the screen may be switched between the AB-system and the Inch-system according to the information to be treated.

Here, the reason why the scanning setting items are different between FIG. 3B and FIGS. 3C to 3F will be described.

The detailed setting screen is generated by referring to the scanning capability generated based on the scanning function information. However, since the general-purpose scanning software 202 does not support the scaling function, the scaling function cannot be added to the scanning function information. Further, even when the scaling function is originally included in the scanning function information, the general-purpose scanning software 202 cannot interpret the scaling function included in the scanning function information, so that the scaling setting cannot be displayed on the detailed setting screen. However, the scanning function extension unit 206 is configured to add the scaling function to the scanning function information 203, and the scanning setting screen extension unit 205 is configured to display the detailed setting screen by referring to the scanning capability. With these configurations, the extension application 204 can display the scaling setting on the detailed setting screen. FIGS. 3C to 3F may additionally include an extension function other than the scaling function.

### Scanning Function Information Editing Process: Scanning Function Extension Unit

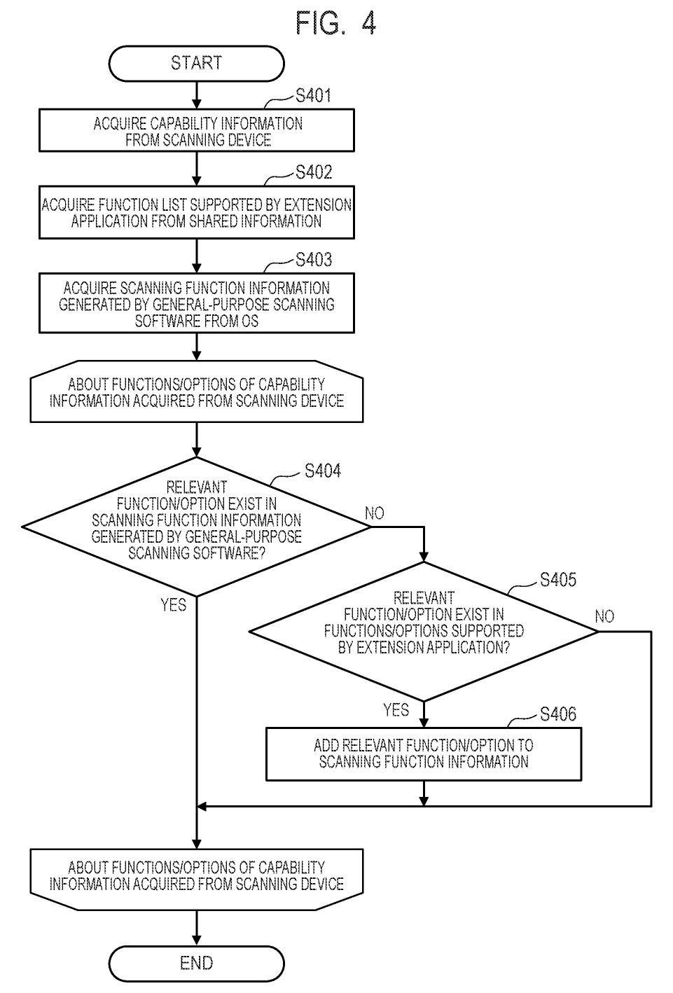

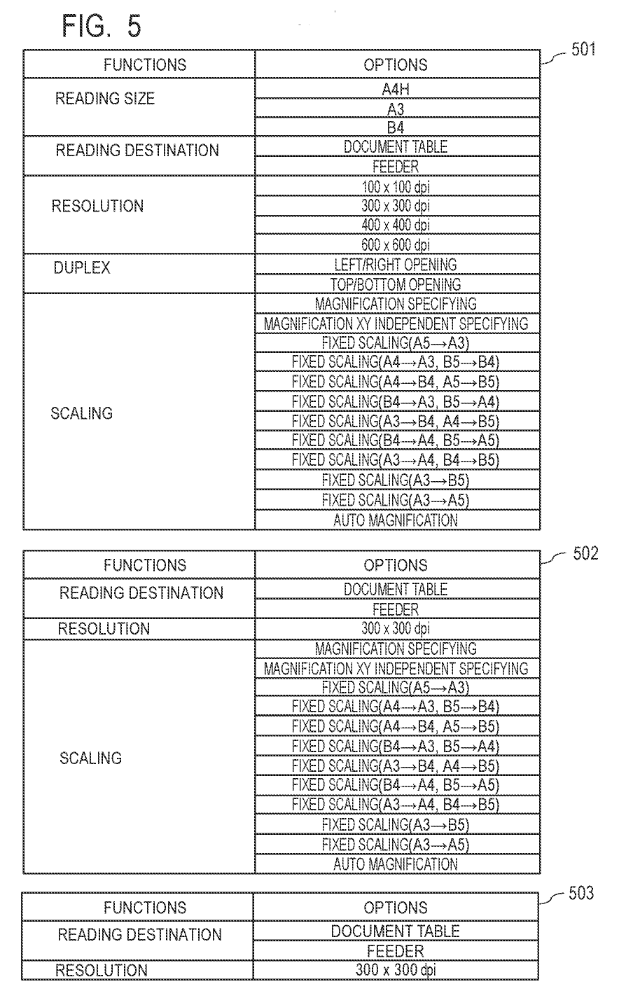

Here, a processing flow in which the scanning function extension unit 206 edits the scanning function information 203 will be described with reference to FIGS. 4 and 5. Each step in the flow is realized by the CPU 111 executing each unit read from the external memory 114 to the RAM 113.

In S401, the scanning function extension unit 206 acquires the capability information from the scanning device 102. The capability information is attribute information indicating the function that can be specified by the scanning device 102 and a setting value related to the attribute information.

A table 501 in FIG. 5 shows an example of a list of the capability information acquired from the scanning device 102. As shown in the table 501, the functions such as reading size specifying and the like, and options that can be set for the respective functions can be acquired from the scanning device 102.

In S402, the scanning function extension unit 206 acquires a scanning function list supported by the extension application 204 from the shared information 208. The scanning function list supported by the extension application 204 is stored in the shared information 208, and all scanning functions that can be processed by the extension application 204 and setting values thereof are described. A table 502 in FIG. 5 shows an example of the scanning function list supported by the extension application 204. The scanning function list supported by the extension application 204 may be updated by updating the extension application 204.

In S403, the scanning function extension unit 206 acquires the scanning function information 203 created by the general-purpose scanning software 202 from the OS. A table 503 in FIG. 5 shows an example of the scanning function list supported by the general-purpose scanning software 202. The scanning function information 203 created by the general-purpose scanning software 202 is created based on the capability information (table 501 in FIG. 5) acquired from the scanning device 102 by the general-purpose scanning software 202.

Since the scanning function information created by the general-purpose scanning software 202 includes only the scanning function supported by the general-purpose scanning software 202 among the capability information acquired from the scanning device 102, the function of the scanning function information is limited. For example, although the capability information (table 501 in FIG. 5) acquired from the scanning device 102 includes the scaling function, the general-purpose scanning software 202 does not support the scaling function, and the scaling function is not described in the scanning function information. By the scanning function extension unit 206 adding functions and options to the scanning function information, the extension application 204 can compensate for lack of functions of the general-purpose scanning software 202. The scanning function extension unit 206 can also delete unnecessary functions and options from the scanning function information created by the general-purpose scanning software 202.

Subsequent S404, S405, and S406 are processes repeatedly performed on the function list of the capability information acquired from the scanning device in S401. In the present embodiment, these processes are the processes that are repeatedly performed for 23 types of “reading size: A4H to scaling: auto magnification” included in the table 501.

In S404, the scanning function extension unit 206 determines whether or not the function/option being processed exists in the scanning function information 203 generated by the general-purpose scanning software 202. When the function/option being processed exists in the scanning function information 203 (YES in S404), the process returns to the beginning of the loop process. Specifically, the next item is selected from among the functions/options of the scanning function acquired from the scanning device 102, and the process of S404 is performed again. When the last item among the functions/options included in the capability information acquired from the scanning device 102 is being processed, the process loops out and the flowchart of FIG. 4 ends. When the function/option being processed does not exist in the scanning function information 203 (NO in S404), the process advances to S405. In the present embodiment, for example, since “reading destination: document table” of the table 501, which is the scanning function of the scanning device 102, also exists in the table 503 which is the scanning function of the general-purpose scanning software 202, YES is determined in S404. On the other hand, since “reading size: A4H” shown in the table 501 does not exist in the table 503, NO is determined, and the process advances to S405.

In S405, the scanning function extension unit 206 determines whether or not the function/option being processed exists among the functions/options supported by the extension application 204. When it is determined that the function/option being processed exists (YES in S405), the process advances to S406. When it is determined that the function/option being processed does not exist (NO in S405), the process of S404 is performed again as in the case where YES is determined in S404, or the process loops out and the process of this flowchart ends. In the present embodiment, for example, in a case where the function being processed is “scaling: magnification specifying”, since the function also exists in the table 502 which is the scanning function of the extension application 204, YES is determined in S405, and the process advances to S406.

In S406, the scanning function extension unit 206 adds the function/option being processed to the scanning function information 203. After the process in S406, the process in S404 is performed again in the same manner as in the case where YES is determined in S404, or the process loops out and the process of this flowchart ends.

As described above, the scanning function extension unit 206 adds, to the scanning function information 203, the function/option that is not supported by the general-purpose scanning software 202, is supported by the scanning device 102, and is supported by the extension application 204. The scanning capability is generated based on the scanning function information edited by this process. Further, the scanning setting screen extension unit 205 generates a display screen based on the generated scanning capability, thereby extending the functions that are not supported by the general-purpose scanning software 202 and displaying the detailed setting screen shown in FIG. 3C.

### Sequence of Scanning Process

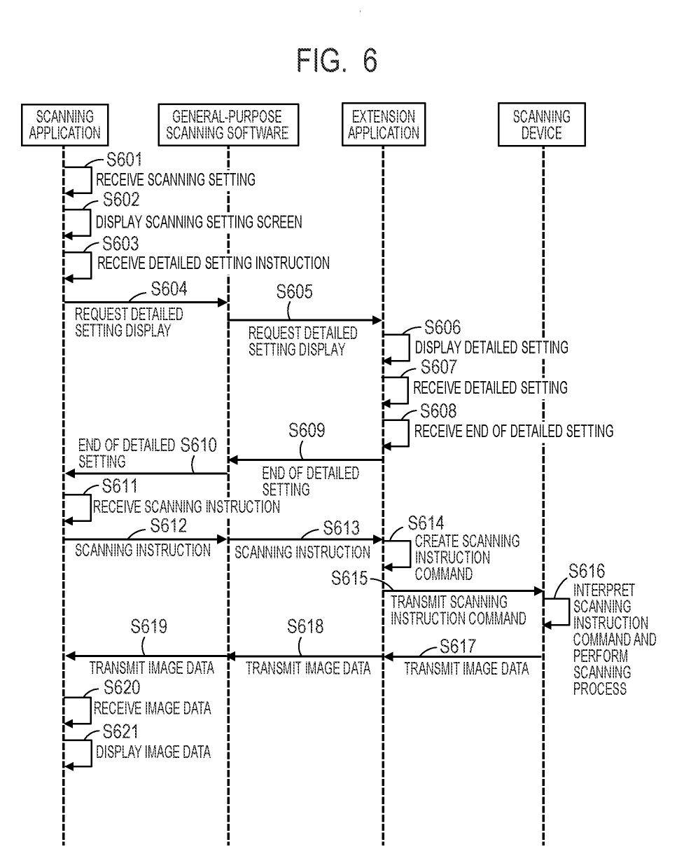

A sequence of the scanning application 201, the general-purpose scanning software 202, the extension application 204, and the scanning device 102 after the scanning application 201 receives the scanning setting will be described with reference to FIG. 6. Each step other than the scanning device 102 in FIG. 6 is performed by the CPU 111 reading the scanning application 201, the general-purpose scanning software 202, and the extension application 204 from the external memory 114 to the RAM 113 and executing them. Each step of the scanning device 102 in FIG. 6 is realized by the CPU 191 of the scanning device 102 reading the program stored in the ROM 192 or the external memory 199 into the RAM 193 and executing the read program.

In S601, the scanning application 201 receives the scanning setting by the user.

The user can instruct the scanning setting to the scanning application 201 by operating the pointing device 117 or the keyboard 118.

In S602, the scanning application 201 displays the scanning setting screen shown in FIG. 3A on the displaying unit 119.

In S603, the scanning application 201 receives the detailed setting instruction. The user can instruct the detailed setting by operating the pointing device 117 or the keyboard 118 to select the control 302.

In S604, the scanning application 201 requests the general-purpose scanning software 202 to display the detailed setting.

In S605, the general-purpose scanning software 202 requests the extension application 204 to display the detailed setting.

In S606, the scanning setting screen extension unit 205 of the extension application 204 causes the displaying unit 119 to display the detailed setting screen shown in FIG. 3C. This is because, as described with reference to FIG. 4, the scaling setting is added to the scanning function information by the scanning function extension unit 206. The scanning setting screen extension unit 205 displays the detailed setting screen of FIG. 3C on the displaying unit 119 with reference to the scanning capability generated based on the added scanning function information. In the present embodiment, since the resolution supported by the extension application 204 is one kind of 300×300 dpi, it is not necessary for the user to select the resolution, and there is no display on the detailed setting screen. Even when not selectable, it may be configured to display it on the detailed setting screen to clearly indicate it to the user.

In S607, the scanning setting screen extension unit 205 receives the detailed setting. In the present embodiment, as shown in FIG. 3C, it is assumed that “reading destination: document table”, “scaling: magnification specifying 50%” are selected by the user. The received setting is stored in the RAM 113 by the CPU 111.

In S608, the scanning setting screen extension unit 205 receives an end of the detailed setting, and instructs to write the received setting to the scanning setting information. The user can operate the pointing device 117 or the keyboard 118 to select the control 306 to instruct the end of the detailed setting. When writing the setting to the scanning setting information, it may be configured to also write an item such as a resolution which is not selected by the user.

In S609, the extension application 204 transmits the end of the detailed setting to the general-purpose scanning software 202.

In S610, the general-purpose scanning software 202 transmits the end of the detailed setting to the scanning application 201.

In S611, the scanning application 201 receives the scanning instruction. The user can instruct the scanning by operating the pointing device 117 or the keyboard 118 to select the control 303.

In S612, the scanning application 201 issues the scanning instruction to the general-purpose scanning software 202.

In S613, the general-purpose scanning software 202 issues the scanning instruction to the extension application 204.

In S614, the extension application 204 creates a scanning instruction command based on the scanning setting information written in S608. In S608, in a case where an item that is not selected by the user such as resolution is not written in the scanning setting information, the extension application 204 may add the item at the time of creating the scanning instruction command in S614. In addition, a configuration may be adopted in which the scanning device 102 operates with a default value without any adding.

In S615, the extension application 204 transmits the scanning instruction command to the scanning device 102 to issue the scanning instruction.

In S616, the scanning device 102 interprets the scanning instruction command and executes the scanning.

At the time of the scanning execution, a necessary image process according to the scanning instruction is performed on the image data.

In the present embodiment, when the scanning setting (scaling: magnification specifying) shown in FIG. 3C is performed, a scanning process of performing a scaling process is performed. That is, the image data in which an enlarging/reducing process has been performed is generated.

In S617, the scanning device 102 transmits the generated image data to the extension application 204.

In S618, the extension application 204 transmits the received image data to the general-purpose scanning software 202.

In S619, the general-purpose scanning software 202 transmits the received image data to the scanning application 201.

In S620, the scanning application 201 receives the image data.

In S621, the scanning application 201 displays the received image data, and ends the process.

### Scanning Process: Extension Application

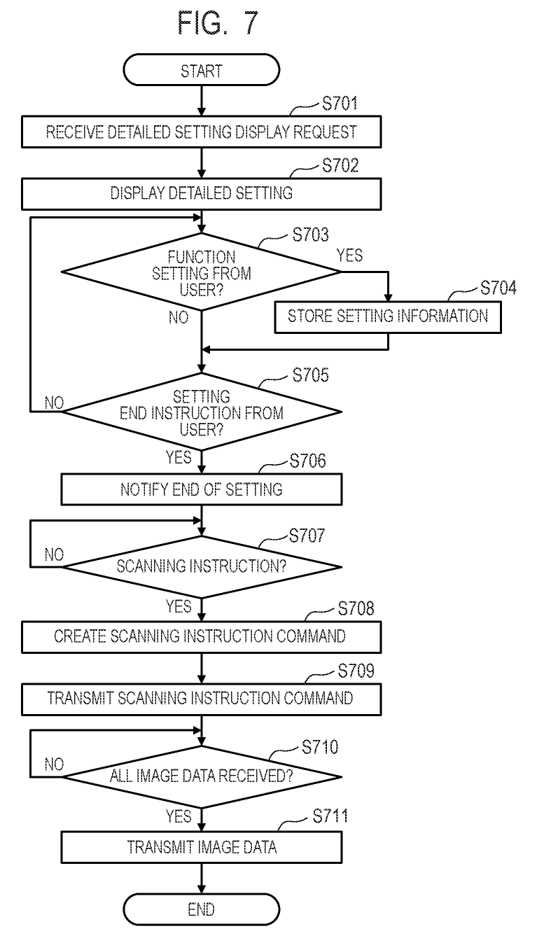

Here, a flow in which the extension application 204 executes the scanning process will be described with reference to FIG. 7. Each step in this flow is realized by the CPU 111 executing each unit read from the external memory 114 to the RAM 113.

In S701, the extension application 204 receives a detailed setting display request.

In S702, the scanning setting screen extension unit 205 of the extension application 204 causes the displaying unit 119 to display the detailed setting screen shown in FIG. 3C. This is because, as described with reference to FIG. 4, the scaling setting is added to the scanning function information by the scanning function extension unit 206. The scanning setting screen extension unit 205 displays the detailed setting screen of FIG. 3C on the displaying unit 119 with reference to the scanning capability generated based on the added scanning function information 203.

In S703, the scanning setting screen extension unit 205 determines whether or not there is function setting by the user. When there is the function setting by the user (YES in S703), the CPU 111 advances the process to S704, and when there is no function setting (NO in S703), the CPU 111 advances the process to S705.

In S704, the detailed setting is received, the received settings are stored in the RAM 113 by the CPU 111, and the process advances to S705.

In S705, the scanning setting screen extension unit 205 determines whether or not there is a setting end instruction from the user. When there is the setting end instruction (YES in S705), the CPU 111 receives the end of the detailed setting, writes the received setting in the scanning setting information, and advances the process to S706. When there is no setting end instruction (NO in S705), the process returns to S703 to determine again whether or not there is the function setting from the user.

In S706, the extension application 204 transmits the end of the detailed setting to the general-purpose scanning software 202.

In S707, the extension application 204 determines whether or not there is the scanning instruction from the general-purpose scanning software 202. When there is the scanning instruction (YES in S706), the CPU 111 advances the process to S708, and when there is no scanning instruction (NO in S706), the process returns to S707 to determine again whether or not there is the scanning instruction from the general-purpose scanning software 202.

In S708, the extension application 204 creates the scanning instruction command based on the scanning setting information written in S705.

As a method of creating the scanning instruction command in S708, there is a method of extending a command of a standard protocol. As an extension method, there is a method of describing a dedicated command in an extension area of the command of the standard protocol. In addition, there are a method of adding a command of a unique standard to the end of the command of the standard protocol, a method of overwriting the command of the standard protocol with a unique command system by the extension application 204, and the like.

When the instruction is issued from the extension application 204, the instruction and communication may be performed using a protocol unique to the vendor (manufacturer) regardless of the standard protocol.

In S709, the extension application 204 transmits the scanning instruction command to the scanning device 102 to issue the scanning instruction.

In S710, the extension application 204 determines whether or not all image data have been received from the scanning device 102. When all the image data have been received (YES in S710), the CPU 111 advances the process to S711, and when not (NO in S710), the process returns to S710 to determine whether or not all the image data have been transmitted from the scanning device 102.

In S711, the extension application 204 transmits the received image data to the general-purpose scanning software 202.

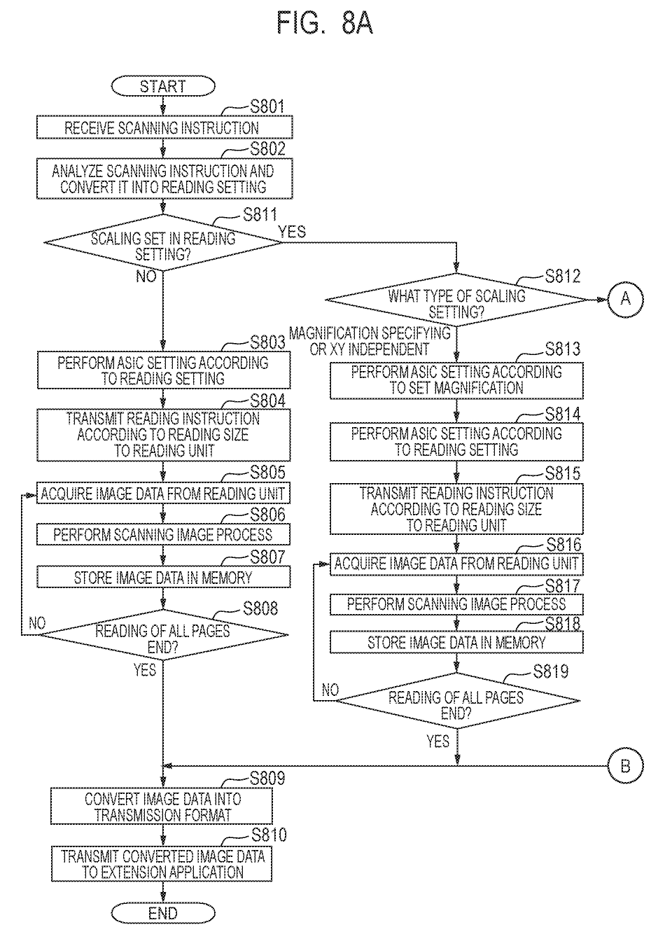

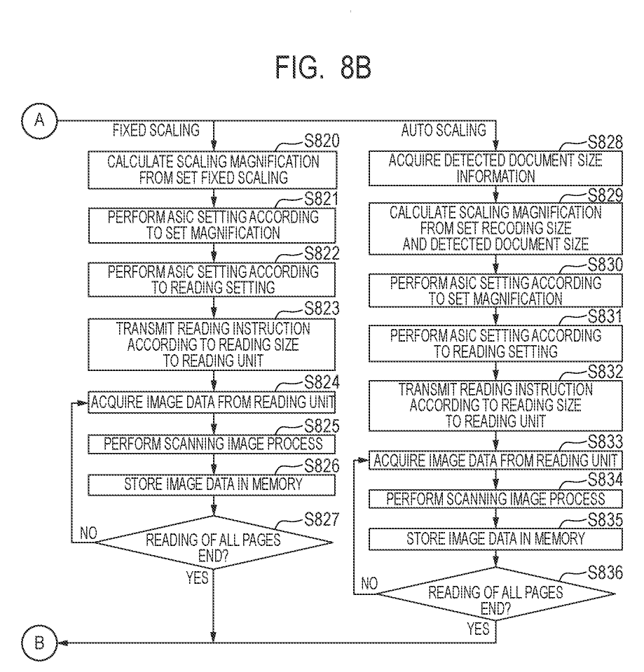

Next, a flow of the scanning process of the scanning device 102 that has received the scanning instruction from the extension application 204 will be described with reference to FIGS. 8A and 8B. Each operation (step) shown in the flowchart of FIGS. 8A and 8B is realized by the CPU 191 executing the program stored in the RAM 192.

In S801, the CPU 191 receives the scanning instruction transmitted from the extension application 204.

In S802, the scanning instruction command received in S801 is analyzed, and the scanning instruction command is converted into a reading setting that allows the scanning device 102 to perform a reading process. In the present embodiment, the reading setting is performed with “document table”, “scaling: magnification specifying 50%”, and “resolution: 300×300 dpi”.

In S811, the CPU 191 determines whether or not the scaling is set in the reading setting. When it is determined that the scaling is not set (NO in S811), the process advances to S803, and when it is determined that the scaling is set (YES in S811), the process advances to S812.

### No Scaling Set

In S803, the CPU 191 determines an ASIC of the image processing unit 190 to be used for performing scanning according to the reading setting converted in S802, and performs ASIC setting.

In S804, the CPU 191 transmits a reading instruction corresponding to the reading setting to the reading unit 195.

In S805, the CPU 191 acquires the image data from the reading unit 195.

In S806, the CPU 191 and the image processing unit 190 perform an image process on the received image data.

In the present embodiment, the conversion is performed to “resolution: 300×300 dpi”. When the reading unit 195 is capable of reading at 300×300 dpi, the reading unit 195 may acquire the image data at 300×300 dpi, and the image process may not be performed in S806.

In S807, the CPU 191 stores the image data in the external memory 199.

In S808, the CPU 191 determines whether or not the scanning process for all pages has ended. When it is determined that the scanning process has not ended (NO in S808), the CPU 191 advances the process to S805, and executes the scanning process of the next page. When it is determined that the process has ended (YES in S808), the CPU 191 advances the process to S809.

In S809, the CPU 191 and the image processing unit 190 convert the image data stored in S807, in accordance with the transmission format setting received in S801. In the present embodiment, the transmission format is not included in the scanning instruction received from the extension application 204. For this reason, although the image data is converted into the default JPEG of the scanning device 102, the transmission format to be converted is not limited to this, and any format can be used as long as it can be handled by the information processing apparatus.

In S810, the converted image data is transmitted to the extension application 204, and all the processes ends.

### Scaling Set

In S812, the CPU 191 determines a type of the scaling setting. When the magnification-specified scaling or the XY independent scaling is determined, the process advances to S813, when the fixed scaling is determined, the process advances to S820, and when the auto scaling is determined, the process advances to S828.

### Magnification-Specified Scaling/XY Independent Scaling

In S813, the CPU 191 determines the ASIC of the image processing unit 190 to be used for performing the scaling process according to the reading setting converted in S802, and performs the setting to the ASIC.

In S814, the CPU 191 determines the ASIC of the image processing unit 190 to be used for performing the scanning according to the reading setting other than the scaling converted in S802, and performs the setting to the ASIC.

In S815, the CPU 191 transmits the reading instruction according to the reading setting to the reading unit 195.

In S816, the CPU 191 acquires the image data from the reading unit 195.

In S817, the CPU 191 and the image processing unit 190 perform the image process on the received image data. In the present embodiment, the process of converting to “resolution: 300×300 dpi” and the process of reduction-scaling the image to 50% are performed.

In S818, the CPU 191 stores the image data in the external memory 199.

In S819, the CPU 191 determines whether or not the scanning process for all pages has ended. When it is determined that the process has not ended (NO in S819), the process advances to S816, and executes the scanning process of the next page. When it is determined that the process has ended (YES in S819), the process advances to S809.

### Fixed Scaling

In S820, the CPU 191 calculates the scaling factor based on the setting of the fixed scaling in the reading setting converted in S802. For example, when the enlargement-scaling from A4 size to A3 size is set, 141.4% is calculated as the magnification.

In S821, the CPU 191 determines the ASIC of the image processing unit 190 to be used for performing the scaling process at the scaling factor calculated in S820, and performs the setting to the ASIC.

In S822, the CPU 191 determines the ASIC of the image processing unit 190 to be used for performing the scanning according to the reading setting other than the scaling converted in S802, and performs the setting to the ASIC.

In S823, the CPU 191 transmits the reading instruction according to the reading setting to the reading unit 195.

In S824, the CPU 191 acquires the image data from the reading unit 195.

In S825, the CPU 191 and the image processing unit 190 perform the image process on the received image data. In the present embodiment, the process of converting to “resolution: 300×300dpi” and the process of scaling the image at the scaling factor of 141.4% calculated in S820 are performed.

In S826, the CPU 191 stores the image data in the external memory 199.

In S827, the CPU 191 determines whether or not the scanning process for all pages has ended. When it is determined that the process has not ended (NO in S827), the process advances to S824, and executes the scanning process of the next page. When it is determined that the process has ended (YES in S827), the process advances to S809.

### Auto Scaling

In S828, the CPU 191 acquires information on the document size detected by the reading unit 195 from the reading unit 195.

In S829, the CPU 191 calculates the scaling factor from the recording size setting of the auto scaling in the reading setting converted in S802 and the document size information acquired in S828. For example, when the recording size setting is A4 size and the document size is A3 size, 70.7% is calculated as the magnification.

In S830, the CPU 191 determines the ASIC of the image processing unit 190 to be used for performing the scaling process at the scaling factor calculated in S829, and performs the setting to the ASIC.

In S831, the CPU 191 determines the ASIC of the image processing unit 190 to be used for performing the scanning according to the reading setting other than the scaling converted in S802, and performs the setting to the ASIC.

In S832, the CPU 191 transmits a reading instruction corresponding to the reading setting to the reading unit 195.

In S833, the CPU 191 acquires the image data from the reading unit 195.

In S834, the CPU 191 and the image processing unit 190 perform the image process on the received image data. In the present embodiment, the process of converting to “resolution: 300×300 dpi” and the process of scaling the image at the scaling factor of 70.7% calculated in S829 are performed.

In S835, the CPU 191 stores the image data in the external memory 199.

In S836, the CPU 191 determines whether or not the scanning process for all pages has ended. When it is determined that the process has not ended (NO in S836), the process advances to S833, and executes the scanning process of the next page. When it is determined that the process has ended (YES in S836), the process advances to S809.

In the scaling process of the present embodiment, the scaling process is realized by using the ASIC, but the scaling process may be realized by a software process, or may be realized by combining the ASIC and the software process.

As described above, in the present embodiment, the scanning setting screen extension unit 205 of the extension application 204 corrects the scanning function information 203 based on the general-purpose scanning software 202, the extension application 204, and the capability information of the scanning device 102. Further, when the detailed setting screen is requested from the user, the setting screen is displayed based on the scanning capability generated from the scanning function information 203, so that the user can set the scaling. After that, upon receiving the scanning instruction in which the setting of the scaling is reflected, the scanning device 102 performs the reading by executing the scaling function. Through the above-described series of processes, the scanning device 102 can realize the scaling function, and can provide the user with the scaling function.

In the present embodiment, the detailed setting screens shown in FIGS. 3C to 3F are used in the configuration of FIG. 2B, but the present disclosure is not limited thereto. For example, when the detailed setting display request is made to the general-purpose scanning software 202 in S604, the general-purpose scanning software 202 may display the detailed setting screen shown in FIG. 3B. Subsequently, after completion of the detailed setting in FIG. 3B, the general-purpose scanning software 202 requests the extension application 204 to display an additional detailed setting screen. Next, the extension application 204 may additionally display the detailed setting screen on which the scaling can be set.

In addition, the scanning instruction to the extension application 204 is performed by the general-purpose scanning software 202, but the present disclosure is not limited thereto. For example, a method of giving an instruction from the scanning application 201 to the extension application 204 or a method of placing the scanning instruction control on the detailed setting screen and directly giving an instruction to the extension application 204 by the user may be employed. The image data may be directly transferred from the extension application 204 to the scanning application 201 without passing through the general-purpose scanning software 202, or may be transferred from the scanning device 102 to the scanning application 201. Alternatively, the received image data may be stored in the external memory 114, and only information of a file path as a storage destination may be transferred.

In the present embodiment, when there is a plurality of pieces of image data, all the pieces of image data are received and then transferred, but a method of transferring the transmitted image data as needed may be employed.

### Embodiment 2

Hereinafter, an embodiment 2 of the present disclosure will be described. In the embodiment 1, first, the scanning device 102 interprets the scanning setting information including the scaling function, and the scanning device 102 performs the scanning process in the specified scaling function.

However, some scanning devices may not support the scaling function at all. In such a case, the user cannot use the scaling function.

Therefore, in the embodiment 2, first, it is determined whether or not the scanning device supports the scaling function from the capability information of the scanning device. Next, when the scanning device supports the scaling function, scanning setting information including the scaling function specified by the user is generated and transferred to the scanning device. On the other hand, when the scanning device does not support the scaling function, the scanning setting information is generated without including the scaling setting, and is transferred to the scanning device. Then, the image data read by the scanning device is subjected to the scaling process by the extension application. This makes it possible to provide the scaling function to the user even when the scanning device does not support the scaling function.

Only differences from the embodiment 1 will be described below.

It is assumed that the scanning device 102 does not support the scaling function. The configuration of the extension application 204 is different from that of the extension application 204 of the embodiment 1. Different from the embodiment 1, even when the scaling function is not included in the capability information acquired from the scanning device, the scanning function extension unit 206 adds the scaling function to the scanning function information 203 in a case where a unit of performing a scaling process on image data is included in the extension application 204. The image data editing unit 207 performs the image scaling process on the image data received from the scanning device 102, based on the scaling function setting set by the user. Details thereof will be described later.

### [Scanning Function Information Editing Process: Scanning Function Extension Unit]

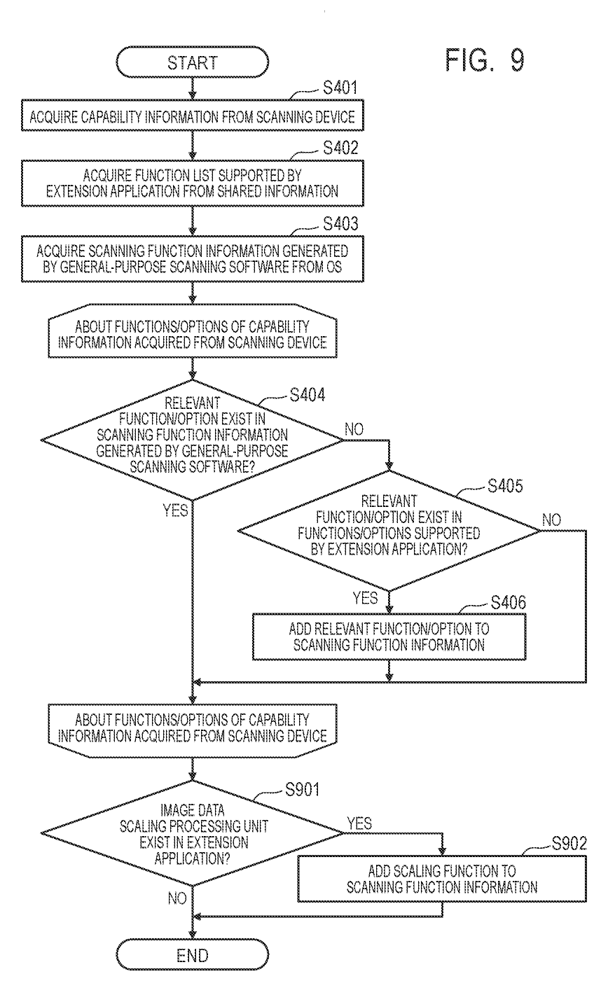

A scanning function information editing process performed by the scanning function extension unit 206 according to the embodiment 2 will be described with reference to FIG. 9. Steps common to those in FIG. 4 will be denoted by the same reference numerals respectively, description thereof will be omitted, and differences will be mainly described. Each step in FIG. 9 is realized by the CPU 111 executing each unit read from the external memory 114 to the RAM 113.

When the repetitive process in S404 to S406 ends, the scanning function extension unit 206 advances the process to S901. Here, the scanning device 102 does not support the scaling function. Therefore, the scaling function is not added to the scanning function information 203 after the end of the process in S404 to S406.

Therefore, in S901 and S902, although not included in the capability information returned from the scanning device 102, a process for adding a function to the scanning function information is performed according to a module included in the extension application 204.

Specifically, in S901, the scanning function extension unit 206 refers to the capability table of the scanning device and the scanning function information 203, and determines whether or not there is a module for performing the scaling process in the extension application 204. When it is determined that there is the module that performs the scaling process (YES in S901), the process advances to S902, and when it is determined that there is no module (NO in S901), the process ends. In the embodiment 2, since the image data editing unit 207 can perform the scaling process, it is determined that the extension application 204 includes the module that performs the scaling process.

In S902, the scanning function extension unit 206 adds the scaling function to the scanning function information.

As described above, the scanning function extension unit 206 first adds, to the scanning function information 203, a function/option that is not supported by the general-purpose scanning software 202, is supported by the scanning device 102, and is supported by the extension application 204. After that, it is determined whether or not the scaling process can be performed by the extension application 204, and when the scaling function can be performed, the scaling function is added to the scanning function information. By this process, even when the scanning device 102 does not support the scaling function, the scanning setting screen extension unit 205 can display the detailed setting screens shown in FIGS. 3A to 3F by generating the display screens based on the scanning capability.

### Sequence of Scanning Process

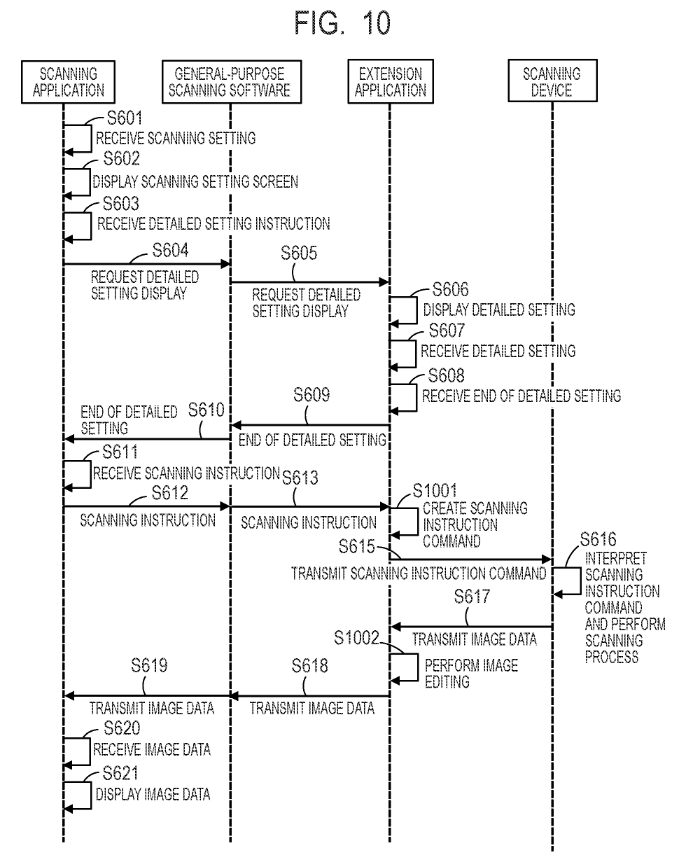

Next, a sequence of the scanning application 201, the general-purpose scanning software 202, the extension application 204, and the scanning device 102 after the scanning application 201 receives the scanning setting will be described with reference to FIG. 10. Each step other than the scanning device 102 in FIG. 10 is performed by the CPU 111 reading the scanning application 201, the general-purpose scanning software 202, and the extension application 204 from the external memory 114 to the RAM 113 and executing them. Each step of the scanning device 102 in FIG. 10 is realized by the CPU 191 of the scanning device 102 reading the program stored in the ROM 192 or the external memory 199 into the RAM 193 and executing the read program. Hereinafter, steps common to those in FIG. 6 will be denoted by the same reference numerals respectively, description thereof will be omitted, and differences will be mainly described.

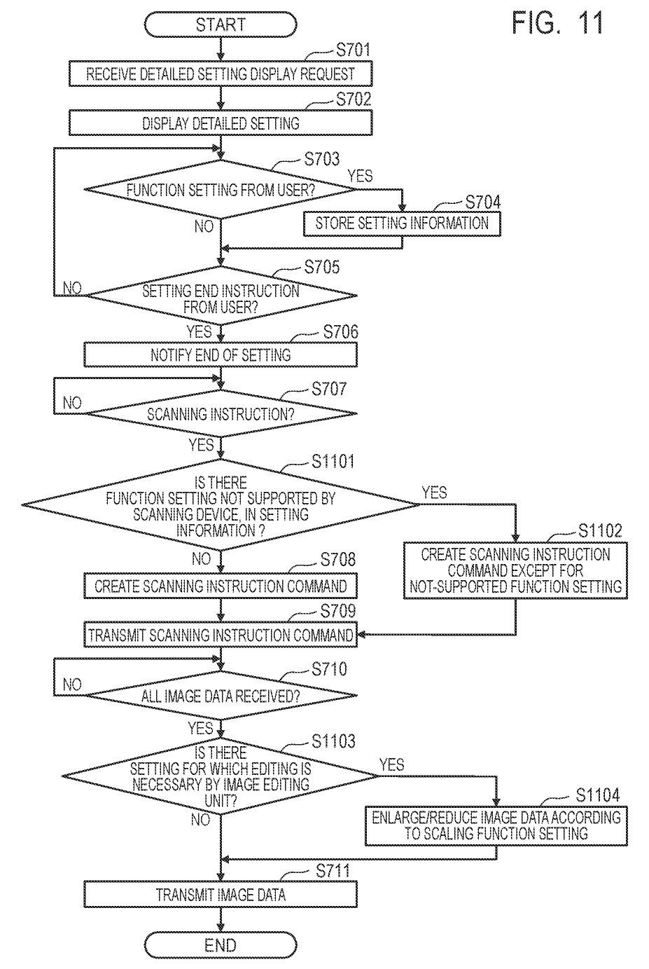

In S1001, the extension application 204 creates a read instruction command. At this time, the detailed movement will be described with reference to the flowchart of FIG. 11.

In S1002, the image data editing unit 207 performs the image editing on the received image data. In the present embodiment, the image process for enlarging/reducing the image data is performed according to the scaling function setting.

Here, a flow in which the extension application 204 executes the scanning process will be described with reference to FIG. 11. Steps common to those in FIG. 7 will be denoted by the same reference numerals respectively, description thereof will be omitted, and differences will be mainly described. Each step is realized by the CPU 111 executing each unit read from the external memory 114 to the RAM 113.

### Scanning Process: Extension Application

In S1101, the extension application 204 acquires the capability information of the scanning device 102 from the shared information 208. When there is no capability information of the scanning device 102, the scanning function extension unit 206 may request the scanning device 102 to store the capability information in the shared information 208.

Based on the acquired capability information and the setting information, the extension application 204 determines whether or not there is a fixed size setting not supported by the scanning device 102.

When it is determined that a function not supported by the scanning device 102 is set (YES in S1101), the CPU 111 advances the process to S1102. In the embodiment 2, since the scaling function not supported by the scanning device 102 is set, the process advances to S1102. When it is determined that the function not supported by the scanning device 102 is not set (NO in S1101), the CPU 111 advances the process to S708.

Next, in S1102, the extension application 204 creates a scanning instruction command excluding unsupported function settings, and the process advances to S707. In the present embodiment, the scaling function is not included in the scanning instruction command.

In S1103, the extension application 204 determines from the setting information whether or not there is a setting that needs to be edited by the image data editing unit 207. When it is determined that there is a setting requiring editing (YES in S1103), the CPU 111 advances the process to S1104. In the embodiment 2, since the scaling function that cannot be executed by the scanning device 102 is set, the process advances to S1104. On the other hand, when it is determined that there is no setting requiring editing (NO in S1103), the CPU 111 advances the process to S711.

Next, in S1104, the image data editing unit 207 performs an enlarging/reducing process on the received image data based on the scaling function setting set in S703.

In the present embodiment, the function setting that is not supported by the scanning device is excluded from the scanning instruction command. However, even when there is a description in the scanning instruction command, the scanning device cannot interpret the instruction command that is not supported and cannot execute the function.

Therefore, the function that is not supported may be described as it is without excluding this function from the scanning instruction command.

As described above, in the embodiment 2, even when the scanning device does not support the scaling function, the scaling function can be provided to the user.

### Embodiment 3

Hereinafter, an embodiment 3 of the present disclosure will be described. In the above embodiments 1 and 2, the extension application 204 and the scanning device 102 exchange data.

In the embodiment 3, the general-purpose scanning software 202 exchanges data with the scanning device 102, and the extension application 204 only extends scanning commands and edits images.

Hereinafter, only differences from the embodiments 1 and 2 will be described.

### Sequence of Scanning Process (Command Extension)

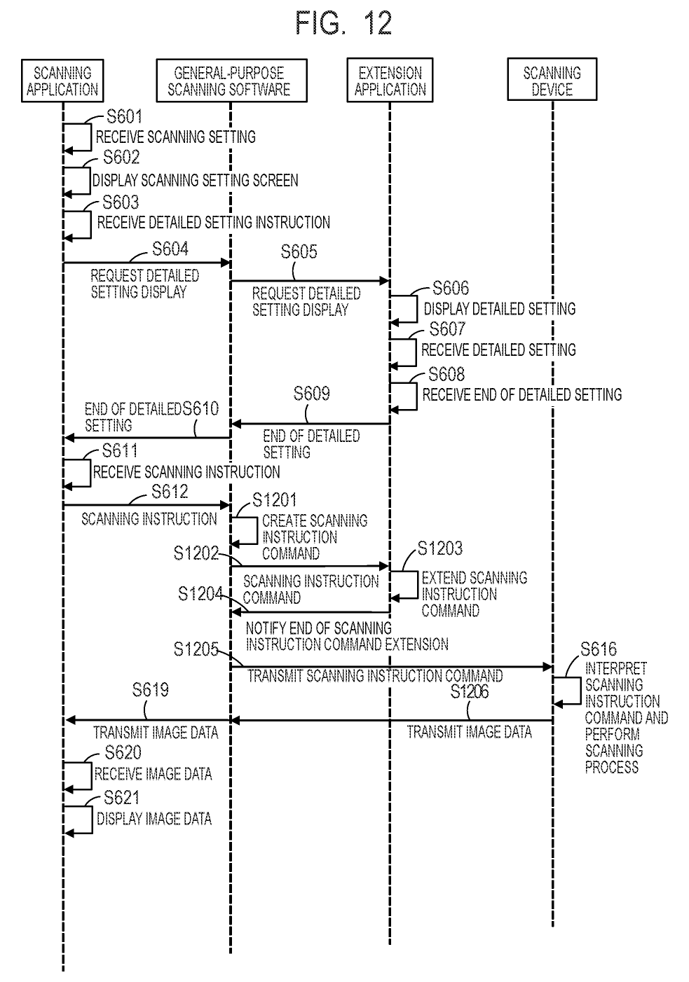

A sequence of the scanning application 201, the general-purpose scanning software 202, the extension application 204, and the scanning device 102 after the scanning application 201 receives the scanning setting will be described with reference to FIG. 12. Steps common to those in FIG. 6 will be denoted by the same reference numerals respectively, description thereof will be omitted, and differences will be mainly described. Each step other than the scanning device 102 in FIG. 12 is performed by the CPU 111 reading the scanning application 201, the general-purpose scanning software 202, and the extension application 204 from the external memory 114 to the RAM 113 and executing them. Each step of the scanning device 102 in FIG. 12 is realized by the CPU 191 of the scanning device 102 reading the program stored in the ROM 192 or the external memory 199 into the RAM 193 and executing the read program.

In S1201, the general-purpose scanning software 202 creates a scanning instruction command. At this time, a function not supported by the general-purpose scanning software 202 is not described in the scanning instruction command.

In S1202, the general-purpose scanning software 202 transfers the created scanning instruction command to the extension application 204.

In S1203, the extension application 204 adds an instruction of a function not supported by the general-purpose scanning software 202 to the received scanning instruction command, changes the existing instruction, and extends the command. In the present embodiment, in S1201, since the scaling setting is not included in the scanning instruction command created by the general-purpose scanning software 202, the scaling setting is added.

In S1204, the extension application 204 transfers the extension scanning instruction command to the general-purpose scanning software 202.

In S1205, the general-purpose scanning software 202 transmits the scanning instruction command to the scanning device 102 to issue the scanning instruction.

In S1206, the general-purpose scanning software 202 receives the image data from the scanning device 102.

### Sequence of Scanning Process (Image Editing)

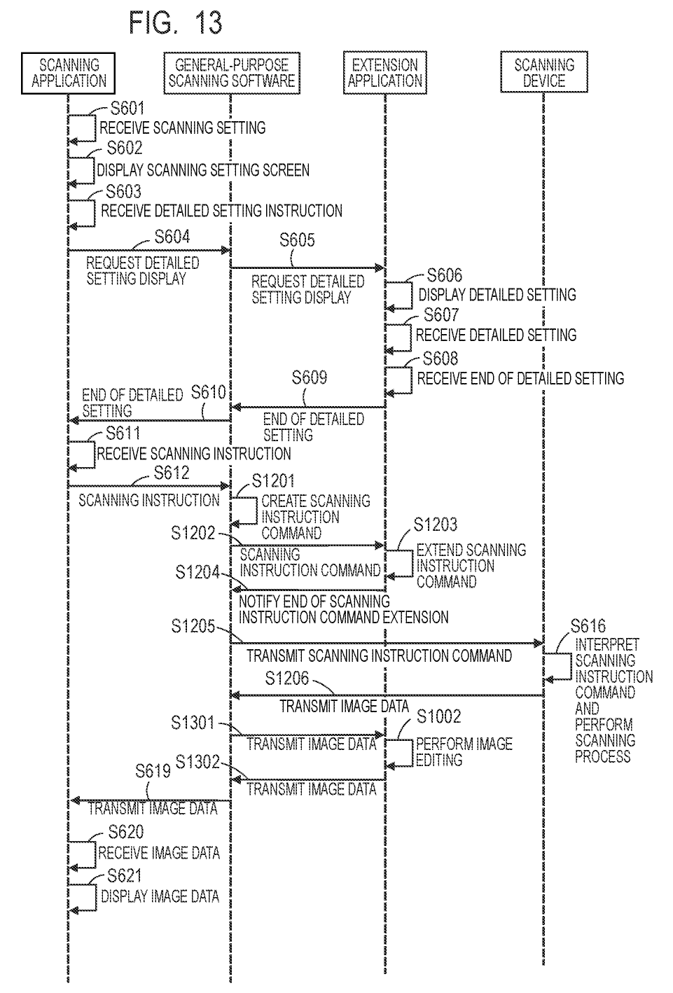

Next, with reference to FIG. 13, a sequence in a case where the image editing is performed by the extension application when the general-purpose scanning software 202 and the scanning device 102 exchange data with each other will be described. Steps common to those in FIG. 12 will be denoted by the same reference numerals respectively, description thereof will be omitted, and differences will be mainly described. Each step other than the scanning device 102 in FIG. 13 is performed by the CPU 111 reading the scanning application 201, the general-purpose scanning software 202, and the extension application 204 from the external memory 114 to the RAM 113 and executing them. Each step of the scanning device 102 in FIG. 13 is realized by the CPU 191 of the scanning device 102 reading the program stored in the ROM 192 or the external memory 199 into the RAM 193 and executing the read program.

In S1301, the general-purpose scanning software 202 transmits the received image data to the extension application 204.

In S1002, the extension application 204 performs the image editing. In the present embodiment, the image process for enlarging/reducing the received image data is performed based on the scaling setting set in the same process as in S1104 of FIG. 11.

In S1302, the extension application 204 transmits the edited image data to the general-purpose scanning software 202.

As described above, in the present embodiment, the extension application 204 extends the scaling instruction command to enable the scanning device 102 to realize the scaling function, and the scaling function can be provided to the user.

### Embodiment 4

Hereinafter, an embodiment 4 of the present disclosure will be described. In the above embodiments 1 to 3, the commands used in the standard protocol are extended and exchanged with the scanning device 102.

In the embodiment 4, a configuration in which a command of the standard protocol is not extended, and a function supported only by the extension application 204 is exchanged with the scanning device 102 by another command will be described.

Hereinafter, only differences from the above-described embodiments will be described.

### Sequence of Scanning Process (Another Command Transmission)

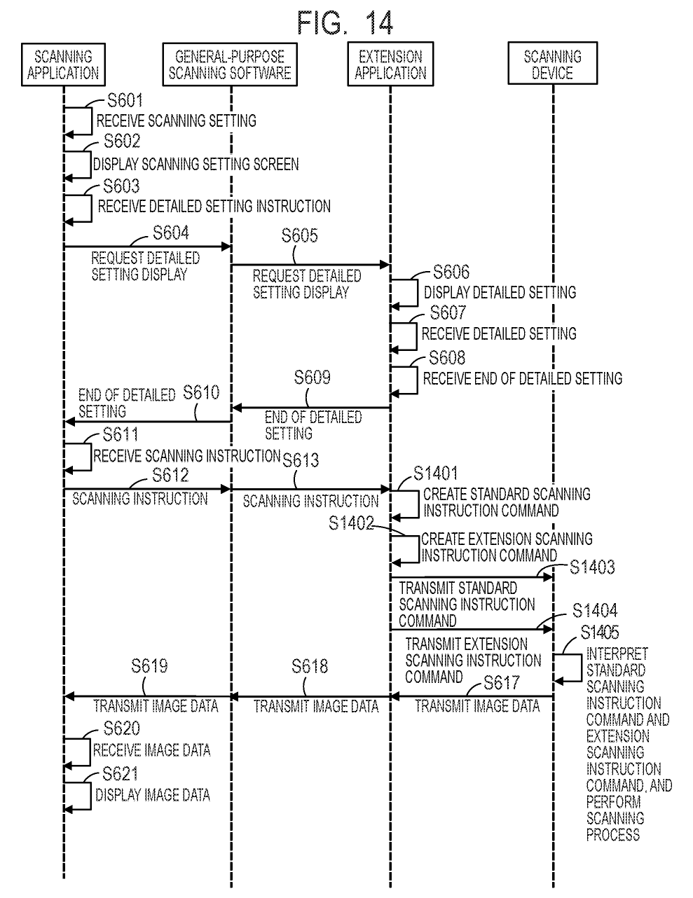

A sequence of the scanning application 201, the general-purpose scanning software 202, the extension application 204, and the scanning device 102 after the scanning application 201 receives the scanning setting will be described with reference to FIG. 14. Each step other than the scanning device 102 in FIG. 14 is performed by the CPU 111 reading the scanning application 201, the general-purpose scanning software 202, and the extension application 204 from the external memory 114 to the RAM 113 and executing them. Each step of the scanning device 102 in FIG. 14 is realized by the CPU 191 of the scanning device 102 reading the program stored in the ROM 192 or the external memory 199 into the RAM 193 and executing the read program. Steps common to those in FIG. 6 will be denoted by the same reference numerals respectively, description thereof will be omitted, and differences will be mainly described.

In S1401, the extension application 204 creates a standard scanning instruction command conforming to the standard protocol. At this time, a function not supported by the standard protocol is not described in the scanning instruction command.

In S1402, the extension application 204 creates an extension scanning instruction command for a function supported only by the extension application 204.

In S1403, the extension application 204 transmits the standard scanning instruction command to the scanning device 102 to issue the scanning instruction.

In S1404, the extension application 204 transmits the extension scanning instruction command to the scanning device 102 to issue the scanning instruction.

In S1405, the scanning device 102 interprets each of the received standard scanning instruction command and extension scanning instruction command, and executes the scanning process.

### Scanning Process: Extension Application

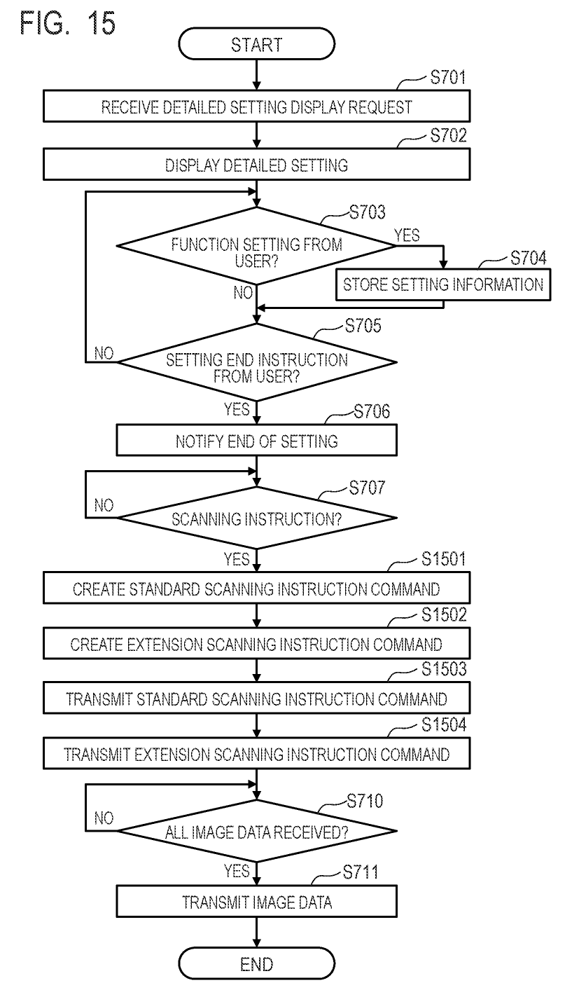

Here, a flow in which the extension application 204 executes the scanning process will be described with reference to FIG. 15. Each step is realized by the CPU 111 executing each unit read from the external memory 114 to the RAM 113. Steps common to those in FIG. 7 will be denoted by the same reference numerals respectively, description thereof will be omitted, and differences will be mainly described.

In S1501, the extension application 204 creates a standard scanning instruction command conforming to the standard protocol.

In S1502, the extension application 204 creates an extension scanning instruction command for a function that is not supported by the standard protocol.

In S1503, the extension application 204 transmits the standard scanning instruction command created in S1501 to the scanning device 102.

In S1504, the extension application 204 transmits the extension scanning instruction command created in S1502 to the scanning device 102.

As described above, in the embodiment 4, the scaling function can be provided to the user by transmitting another scanning instruction command in regard to the function not supported by the standard protocol from the extension application.

According to the present disclosure, the scaling function can be made available to the user by the program that supports the general-purpose scanning software that can be commonly used by the scanning devices respectively provided by the plurality of manufacturers.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174618, filed October 3, 2024, which is hereby incorporated by reference herein in its entirety.

What is claimed is:

1. A non-transitory computer-readable storage medium that stores a program supporting general-purpose software available for image processing apparatuses provided by a plurality of manufacturers,
wherein, when executed, the program causes a computer to perform a method comprising:
causing a display unit to display an object that receives a setting related to a scaling function of scaling an image acquired by reading a document using the image processing apparatus; and
outputting a reading instruction of the document to the image processing apparatus according to the setting received by the object.

2. The non-transitory computer-readable storage medium according to claim 1, wherein the setting related to the scaling function includes specifying a magnification related to the scaling function.

3. The non-transitory computer-readable storage medium according to claim 2, wherein the setting related to the scaling function includes specifying the magnification in a first direction of the image and specifying the magnification in a second direction of the image.

4. The non-transitory computer-readable storage medium according to claim 2, wherein the setting related to the scaling function includes specifying conversion from a fixed size to another fixed size.

5. The non-transitory computer-readable storage medium according to claim 2, wherein the setting related to the scaling function includes the magnification based on a document size and a size specified by a user.

6. The non-transitory computer-readable storage medium according to claim 1, wherein the setting related to the scaling function is received by selecting the object from among a plurality of objects displayed.

7. The non-transitory computer-readable storage medium according to claim 1, wherein the method further comprises:
determining whether the image processing apparatus can execute scaling that is based on the setting related to the scaling function received by the object; and
in response to determining that the image processing apparatus cannot execute the scaling that is based on the setting, performing scaling on the image of the document read by the image processing apparatus, based on the setting.

8. The non-transitory computer-readable storage medium according to claim 7, wherein the method further comprises:
in response to determining that the image processing apparatus cannot execute the scaling that is based on the setting, outputting an instruction command to the image processing apparatus that does not include the setting.

9. A method of supporting general-purpose software available for image processing apparatuses provided by a plurality of manufacturers, the method comprising:
displaying an object that receives a setting related to a scaling function of scaling an image acquired by reading a document using the image processing apparatus; and
outputting a reading instruction of the document to the image processing apparatus according to the setting received by the object.

10. An information processing apparatus that has a program supporting general-purpose software available for image processing apparatuses provided by a plurality of manufacturers, the information processing apparatus comprising:
at least one memory and at least one processor which function as:
a display unit configured to display an object that receives a setting related to a scaling function of scaling an image acquired by reading a document using the image processing apparatus; and
an outputting unit configured to output a reading instruction of the document to the image processing apparatus according to the setting received by the object.
